(19) United States
(12) Patent Application Publication
(10) Pub. No.: US 2023/0060160 A1
(43) Pub. Date: Mar. 2, 2023

(54) AC GENERATION CIRCUIT AND AC GENERATION DEVICE

(71) Applicant: HONDA MOTOR CO., LTD., Tokyo (JP)

(72) Inventor: Yasumichi Onuki, Wako-shi (JP)

(21) Appl. No.: 17/895,098

(22) Filed: Aug. 25, 2022

(30) Foreign Application Priority Data
Aug. 31, 2021 (JP) 2021-141255

(51) Int. Cl. H01M 10/625; H01M 10/615; B60L 58/27

(52) U.S. Cl. CPC H01M 10/625; H01M 10/615; B60L 58/27; H01M 2220/20; B60L 2240/545

(57) ABSTRACT

An AC generation circuit includes a plurality of child circuits connected to positive electrodes and negative electrodes of a plurality of secondary batteries connected in series, wherein a negative electrode side of one of two adjacent child circuits among the plurality of child circuits and a positive electrode side of the other child circuit are connected at a first intermediate connection point, the first intermediate connection point is connected to a second intermediate connection point at which a negative electrode of one of two adjacent secondary batteries among the plurality of secondary batteries and a positive electrode of the other secondary battery are connected, and a capacitor is provided at least some of positions between one or more first intermediate connection points and one or more second intermediate connection points.

### CROSS-REFERENCE TO RELATED APPLICATION

Priority is claimed on Japanese Patent Application No. 2021-141255, filed Aug. 31, 2021, the content of which is incorporated herein by reference.

### BACKGROUND

### Field of the Invention

The present invention relates to an alternating current (AC) generation circuit and an AC generation device.

### Description of Related Art

In order to reduce adverse effects on the global environment (for example, in order to reduce NOₓ, SOₓ, and CO₂), electric vehicles that travel using electric power stored in secondary batteries are becoming widespread. It is known that when the temperature of a secondary battery drops below an appropriate range, the charge/discharge characteristics of the secondary battery deteriorate. In this regard, an invention of a secondary battery temperature increasing device capable of effectively increasing the temperature of a secondary battery by making the second battery to effectively generate heat from the inside when the temperature of the secondary battery is low is disclosed (WO 2011/004464).

### SUMMARY

However, when a high voltage is required, a plurality of secondary batteries may be connected in series and used as a power source. In the technology described in Patent Document 1, when a plurality of batteries are connected in series and used, a raised temperature of the batteries may vary due to variation in the voltage of each battery.

An object of the present invention devised in view of such circumstances is to provide an AC generation circuit and an AC generation device capable of improving energy efficiency by uniformly increasing the temperatures of a plurality of secondary batteries connected in series and reducing a loss due to resistance.

An AC generation circuit and an AC generation device according to the present invention employ the following configurations.

(1): An AC generation circuit according to one aspect of the present invention is an AC generation circuit including a plurality of child circuits connected to positive electrodes and negative electrodes of a plurality of secondary batteries connected in series, wherein a negative electrode side of one of two adjacent child circuits among the plurality of child circuits and a positive electrode side of the other child circuit are connected at a first intermediate connection point, the first intermediate connection point is connected to a second intermediate connection point at which a negative electrode of one of two adjacent secondary batteries among the plurality of secondary batteries and a positive electrode of the other secondary battery are connected, and a capacitor is provided at least some of positions between one or more first intermediate connection points and one or more second intermediate connection points.

(2): In the aforementioned aspect of (1), the capacitor is provided at each of positions at which a plurality of first intermediate connection points and a plurality of second intermediate connection points are connected.

(3): In the aforementioned aspect of (1), the capacitor is provided at some of the positions at which the plurality of first intermediate connection points and the plurality of second intermediate connection points are connected, and a current limiting element is provided at some or all of positions at which the capacitor is not provided among the positions at which the plurality of first intermediate connection points and the plurality of second intermediate connection points are connected.

(4): In the aforementioned aspect of (1), each of the child circuits includes a plurality of child circuit capacitors, and a connection relationship of the child circuit capacitors is switched between serial/parallel connections with respect to a corresponding secondary battery to generate alternating current.

(5): In the aforementioned aspect of (1), the capacitor provided between the first intermediate connection point and the second intermediate connection point is connected to a branch bus bar constituting or connected to the first intermediate connection point via a first connection tab, and is connected to a bus bar constituting the second intermediate connection point via a second connection tab, the capacitor, the first connection tab, and the second connection tab are covered with an insulating member by being sealed with a resin mold or the like, and at least parts of the branch bus bar and the bus bar are exposed to the outside of a portion covered with the insulating member.

(6): An AC generation device according to another aspect of the present invention is an AC generation device including the AC generation circuit according to claim 1, and a control unit configured to cause alternating current power with different phases in some or all of the plurality of child circuits.

According to the aforementioned aspects of (1) to (6), it is possible to improve energy efficiency by uniformly increasing the temperatures of a plurality of secondary batteries connected in series and reducing a loss due to resistance.

According to the aforementioned aspect of (3), it is possible to enhance the safety of the circuit by uniformly increasing the temperature of the plurality of secondary batteries and increasing the number of fuses.

According to the aforementioned aspect of (5), since a branch bus bar part is galvanically insulated from a battery module, it does not become a live line part and thus it is not necessary to take measures for preventing an exposed portion of a branch bus bar from short-circuiting at the time of assembling a battery pack.

### BRIEF DESCRIPTION OF THE DRAWINGS

FIG. 1 is a diagram showing an example of a configuration of an AC generation device and an AC generation circuit of a first embodiment.

FIG. 2 is a diagram showing an example of changes in voltages and currents generated in the AC generation circuit according to on/off of switches of child circuits of the first embodiment.

FIG. 3 is a diagram showing an example of a configuration of an AC generation circuit of a comparative example of the first embodiment.

FIG. 4 is a diagram showing an example of changes in voltages and currents generated in the AC generation circuit according to on/off of switches of child circuits of the comparative example of the first embodiment.

FIG. 5 is a diagram showing an example of a configuration of an AC generation device and an AC generation circuit of a second embodiment.

FIG. 6 is a diagram showing an example of changes in voltages and currents generated in the AC generation circuit according to on/off switches of child circuits of the second embodiment.

FIG. 7 is a diagram showing an example of a configuration of an AC generation circuit of a comparative example of the second embodiment.

FIG. 8 is a diagram showing an example of changes in voltages and currents generated in the AC generation circuit according to on/off switches of child circuits of the comparative example of the second embodiment.

FIG. 9 is a diagram showing an example of a configuration of an AC generation device and an AC generation circuit of a third embodiment.

FIG. 10 is a diagram showing an example of a configuration of an AC generation device and an AC generation circuit according to modified example 1 of the third embodiment.

FIG. 11 is a diagram showing an example of a configuration of an AC generation device and an AC generation circuit according to modified example 2 of the third embodiment.

FIG. 12 is a diagram showing an example of arrangement of a capacitor provided between a first intermediate connection point and a second intermediate connection point.

### DESCRIPTION OF EMBODIMENTS

Hereinafter, embodiments of an AC generation circuit and an AC generation device of the present invention will be described with reference to the drawings. The AC generation circuit and the AC generation device are attached to a secondary battery and increase the temperature of the secondary battery when necessary. In particular, the AC generation circuit of the present invention can increase the temperature of each secondary battery in a configuration in which a plurality of secondary batteries are connected in series.

### First Embodiment

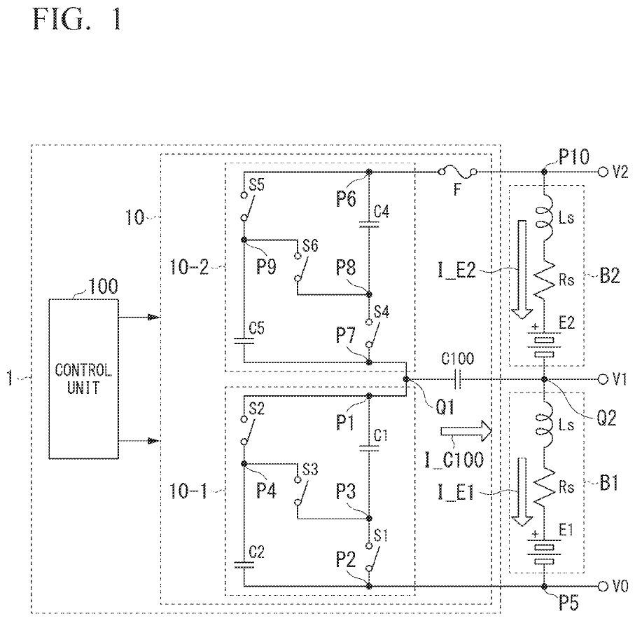

FIG. 1 is a diagram showing an example of a configuration of an AC generation device 1 and an AC generation circuit 10 of a first embodiment. In the present embodiment, each of a secondary battery and the AC generation circuit is provided in two stages. That is, the secondary battery includes a first secondary battery B1 and a second secondary battery B2 connected in series, and the AC generation circuit 10 includes a first child circuit 10-1 provided corresponding to the first secondary battery B1 and a second child circuit 10-2 provided corresponding to the second secondary battery B2. The positive electrode of the first secondary battery B1 is connected to the negative electrode of the second secondary battery B2. The positive electrode side of the first child circuit 10-1 is connected to the positive electrode of the first secondary battery B1, and the negative electrode side of the first child circuit 10-1 is connected to the negative electrode of the first secondary battery B1. The positive electrode side of the second child circuit 10-2 is connected to the positive electrode of the second secondary battery B2, and the negative electrode side of the second child circuit 10-2 is connected to the negative electrode of the second secondary battery B2. Further, the AC generation circuit 10 includes a fuse F and a capacitor C100. The AC generation device 1 includes the AC generation circuit 10 and a control unit 100.

In FIG. 1, the characteristics of the first secondary battery B1 are virtually represented as a storage part E1, a resistance R_{S}, and an inductance L_{S}. Further, the characteristics of the second secondary battery B2 are virtually represented as a storage unit E1, a resistance R_{S}, and an inductance L_{S}.

Each of the first secondary battery B1 and the second secondary battery B2 is a battery that can be repeatedly charged and discharged, such as a lithium ion battery. Each of the first secondary battery B1 and the second secondary battery B2 may be simply a single battery or may include a plurality of battery blocks which are electrically connected in series or in parallel. The electric power supplied by the first secondary battery B1 and the second secondary battery B2 may be supplied to a load via a DC-AC converter, a DC-DC converter, or the like which is not illustrated.

A contact P1 on the positive electrode side of the first child circuit 10-1 is connected to a first intermediate connection point Q1. A contact P2 on the negative electrode side of the first child circuit 10-1 is connected to a contact P5 which is the negative electrode of the first secondary battery B1. Capacitors C1 and C2 and switches S1 to S3 for generating alternating current are provided between the contact P1 and the contact P2. This configuration corresponds to the first child circuit 10-1.

In the first child circuit 10-1, a first path through which the capacitor C1 and the switch S1 are connected in series and a second path through which the switch S2 and the capacitor C2 are connected in series are present in parallel between the contact P1 and the contact P2. A contact P3 between the capacitor C1 and the switch S1 and a contact P4 between the switch S2 and the capacitor C2 are connected through a third path. A switch S3 is provided on the third path.

A contact P6 on the positive electrode side of the second child circuit 10-2 is connected to the positive electrode of the second secondary battery B2 via the fuse F. A contact P7 on the negative electrode side of the second child circuit 10-2 is connected to the first intermediate connection point Q1. Capacitors C4 and C5 and switches S4 to S6 for generating alternating current are provided between the contact P6 and the contact P7. This configuration corresponds to the second child circuit 10-2.

In the second child circuit 10-2, a first path through which the capacitor C4 and the switch S4 are connected in series and a second path through which the switch S5 and the capacitor C5 are connected in series are present in parallel between the contact P6 and the contact P7. A contact P8 between the capacitor C4 and the switch S4 and a contact P9 between the switch S5 and the capacitor C5 are connected through the third path. A switch S6 is provided on the third path. A second intermediate connection point Q2 is provided between the positive electrode of the first secondary battery B1 and the negative electrode of the second secondary battery B2.

The fuse F is provided between the contact P6 and a contact P10. When the current flowing through the fuse F becomes greater than a certain current, the fuse F melts to cut off the current. The fuse F is an example of a “current limiting element.” For example, another current limiting element such as a positive temperature coefficient (PTC) thermistor may be used.

The capacitor C100 is provided between the first intermediate connection point Q1 and the second intermediate connection point Q2. The capacitor C100 selectively passes an alternating-current component flowing between the first intermediate connection point Q1 and the second intermediate connection point Q2 and curbs passing of a direct-current component.

The control unit 100 is realized by, for example, a central processing unit (CPU), large scale integration (LSI), an application specific integrated circuit (ASIC), an integrated circuit (IC), or the like. The control unit 100 controls on/off of each of the switches S1 to S6 included in the first child circuit 10-1 and the second child circuit 10-2, for example, such that alternating current is generated in each of the first child circuit 10-1 and the second child circuits 10-2. In the present embodiment, the capacitors C1, C2, C4, and C5 are examples of child circuit capacitors, and their capacities are set to be the same. The capacitance of the capacitor C100 may be the same as or different from those of the capacitors. Further, the control unit 100 may generate alternating currents with different phases in the first child circuit 10-1 and the second child circuit 10-2 by making control phases of the switches of the child circuits different.

In the first child circuit 10-1, the control unit 100 switches the capacitor C1 and the capacitor C2 between serial/parallel connections with respect to the first secondary battery B1, for example, by controlling the switches S1, S2, and S3. The control unit 100 causes the capacitor C1 and the capacitor C2 to be parallel to the first secondary battery B1 by turning on the switch S1 and the switch S2 and turning off the switch S3 and causes the capacitor C1 and the capacitor C2 to be in series with the first secondary battery B1 by turning off the switch S1 and the switch S2 and turning on the switch S3.

When the capacitor C1 and the capacitor C2 are parallel to the first secondary battery B1, the voltages of the capacitor C1 and the capacitor C2 approach the voltage of the first secondary battery B1 (the capacitors are charged). On the other hand, when the capacitor C1 and the capacitor C2 are in series with the first secondary battery B1, the voltages of the capacitor C1 and the capacitor C2 approach ½ of the voltage of the first secondary battery B1 (the capacitors are discharged). By repeating this, alternating current is generated between the first child circuit 10-1 and the first secondary battery B1. The control unit 100 controls the switches S1, S2, and S3 in this way.

In the second child circuit 10-2, the control unit 100 switches the capacitor C4 and the capacitor C5 between serial/parallel connections with respect to the second secondary battery B2, for example, by controlling the switches S4, S5, and S6. The control unit 100 causes the capacitor C4 and the capacitor C5 to be parallel to the second secondary battery B2 by turning on the switch S4 and the switch S5 and turning off the switch S6 and causes the capacitor C4 and the capacitor C5 to be in series with the second secondary battery B2 by turning off the switch S4 and the switch S5 and turning on the switch S6.

When the capacitor C4 and the capacitor C5 are parallel to the second secondary battery B2, the voltages of the capacitor C4 and the capacitor C5 approach the voltage of the second secondary battery B2 (the capacitors are charged). On the other hand, when the capacitor C4 and the capacitor C5 are in series with the second secondary battery B2, the voltages of the capacitor C4 and the capacitor C5 approach ½ of the voltage of the second secondary battery B2 (the capacitors are discharged). By repeating this, alternating current is generated between the second child circuit 10-2 and the second secondary battery B2. The control unit 100 controls the switches S4, S5, and S6 in this way.

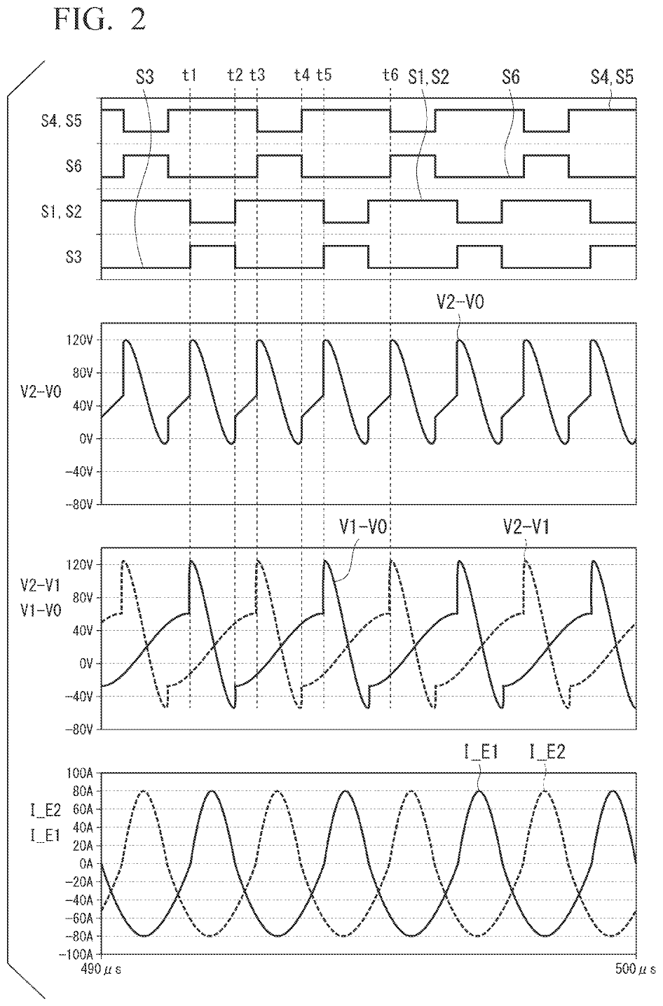

FIG. 2 is a diagram showing an example of changes in voltages and currents generated in the AC generation circuit 10 according to on/off the switches of the child circuits of the first embodiment. The changes shown in this figure are results of simulations performed by the inventor of the present application. As shown in the figure, in the first child circuit 10-1, the capacitor C1 and the capacitor C2 are connected in series with the first secondary battery B1 at a time t1. Before the time t1, the sum of the voltages of the capacitors C1 and the capacitors C2 was greater than the voltage of the first secondary battery B1, and thus a voltage V1-V0 greatly increases at the time t1. Thereafter, each of the capacitor C1 and the capacitor C2 is discharged and the first secondary battery B1 is charged by the discharged electric power until a time t2. As the time t2 approaches, a current I_E1 is maintained in the direction of flowing from each of the capacitor C1 and the capacitor C2 to the first secondary battery B1 due to the presence of the inductance L_{S}, and thus the voltage V1-V0 drops to a lower limit value. The capacitor C1 and the capacitor C2 are connected in parallel to the first secondary battery B1 from the time t2 to a time t5, and thus their voltages approach the voltage of the first secondary battery B1.

In the second child circuit 10-2, the capacitor C4 and the capacitor C5 are connected in series to the second secondary battery B2 at a time t3. Before the time t3, the sum of the voltages of the capacitor C4 and the capacitor C5 was greater than the voltage of the second secondary battery B2, and thus a voltage V2-V1 greatly increases at the time t3. Thereafter, each of the capacitor C4 and the capacitor C5 is discharged and the second secondary battery B2 is charged by the discharged electric power until a time t4. As the time t4 approaches, a current I_E2 is maintained in the direction of flowing from each of the capacitor C4 and the capacitor C5 to the second secondary battery B2 due to the presence of the inductance L_{S}, and thus the voltage V2-V1 drops to a lower limit value. The capacitor C4 and the capacitor C5 are connected in parallel to the second secondary battery B2 from the time t4 to a time t6, and thus their voltages approach the voltage of the second secondary battery B2.

Since the capacitor C100 is provided, it is possible to cause a certain amount of alternating-current component to pass between the first intermediate connection point Q1 and the second intermediate connection point Q2 while curbing a steep current flowing due to short-circuiting or the like. Therefore, even if the voltages of the first secondary battery B1 and the second secondary battery B2 are different at the time when the AC generation device 1 starts to operate, alternating current is generated such that a difference in alternating current energy is canceled, and the amplitudes of the current I_E1 and the current I_E2 flowing therethrough become uniform. Moreover, as compared to a comparative example which will be described later, a loss due to resistance can be reduced since no fuse is provided near the first intermediate connection point Q1 and the second intermediate connection point Q2.

### Comparison with Comparative Example

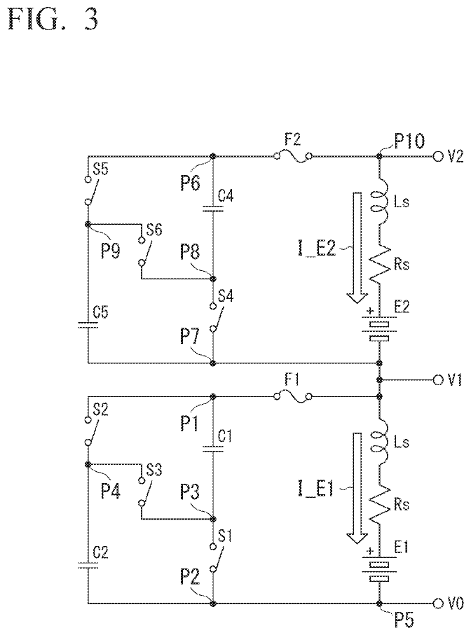

Here, comparison with a comparative example of the first embodiment will be described. FIG. 3 is a diagram showing an example of a configuration of an AC generation circuit of the comparative example of the first embodiment. In FIG. 3, those having the same functions as those in the first embodiment are denoted by the same reference numerals. As shown in FIG. 3, the AC generation circuit of the comparative example is not provided with the capacitor C100 and is provided with a fuse F1 between the contact P1 and the positive electrode of the first secondary battery B1. In this case, a loss due to the resistance of the fuse F1 increases. Further, since the capacitor C100 is not present, the amplitudes of the current I_E1 and the current I_E2 may not be uniform when the voltages of the first secondary battery B1 and the second secondary battery B2 are different.

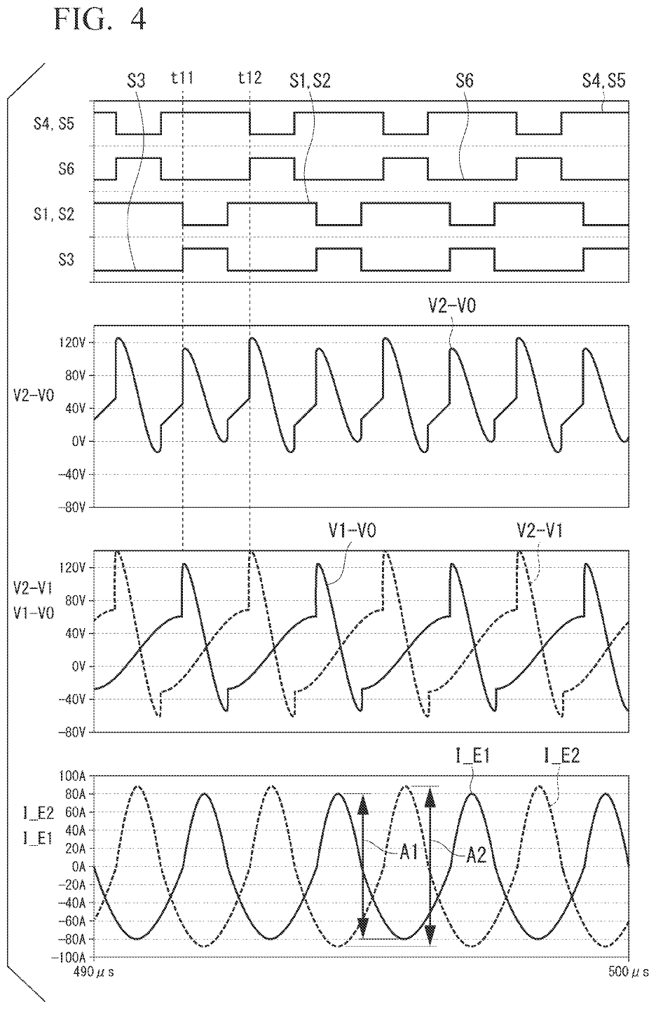

FIG. 4 is a diagram showing an example of changes in voltages and currents generated in the AC generation circuit 10 according to on/off of switches of child circuits of the comparative example of the first embodiment. The changes shown in this figure are also results of simulations performed by the inventor of the present application. As shown in FIG. 4, the amplitude A1 of the current I_E1 and the amplitude A2 of the current I_E2 are not uniform. As a result, rising temperatures of the first secondary battery B1 and the second secondary battery B2 vary, and thus the AC generation device 1 may not be able to uniformly increase the temperatures of the first secondary battery B1 and the second secondary battery B2.

On the other hand, according to the AC generation circuit 10 of the first embodiment, since the capacitor C100 is provided, the potential of the first intermediate connection point Q1 between the first child circuit and the second child circuit is adjusted and the amplitude of the current I_E1 and the amplitude of the current I_E2 become uniform, and thus the AC generation device 1 can uniformly increase the temperatures of the first secondary battery B1 and the second secondary battery B2 and reduce a loss due to resistance.

### Second Embodiment

The first embodiment illustrates that each of the secondary battery and the AC generation circuit is provided in two stages. Instead of this, each of the secondary battery and the AC generation circuit may be provided in three or more stages. In a second embodiment, it is assumed that a three-stage secondary battery and AC generation circuit are provided.

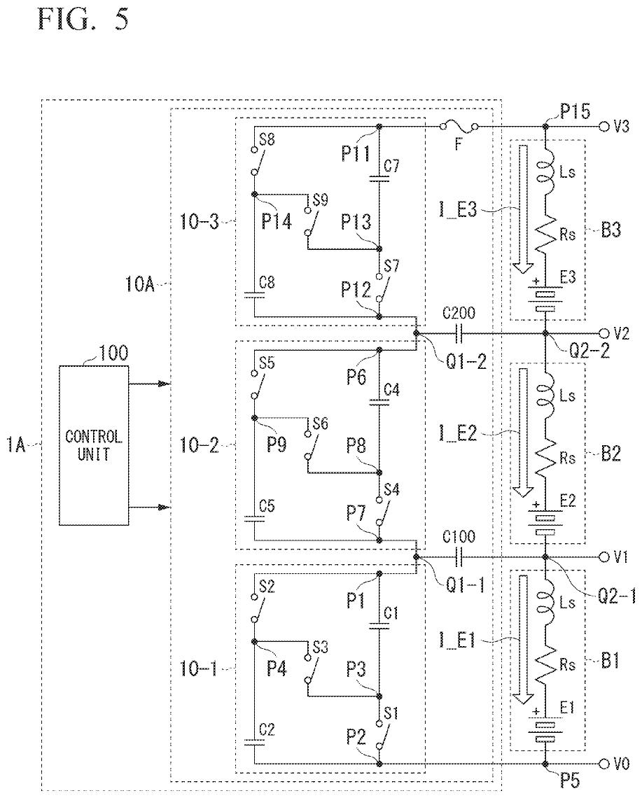

FIG. 5 is a diagram showing an example of a configuration of an AC generation device 1A and an AC generation circuit 10A of the second embodiment. The second embodiment includes a third child circuit 10-3 in addition to the configuration of the first embodiment.

A contact P11 on the positive electrode side of the third child circuit 10-3 is connected to the positive electrode of a third secondary battery B3 via the fuse F. A contact P12 on the negative electrode side of the third child circuit 10-3 is connected to a first intermediate connection point Q1-2. Capacitors C7 and C8 and switches S7 to S9 for generating alternating current are provided between the contact P11 and the contact P12.

In the third child circuit 10-3, a first path through which the capacitor C7 and the switch S7 are connected in series and a second path through which the switch S8 and the capacitor C8 are connected in series are present in parallel between the contact P11 and the contact P12. A contact P13 between the capacitor C7 and the switch S7 and a contact P14 between the switch S8 and the capacitor C8 are connected through the third path. The switch S9 is provided on the third path. A second intermediate connection point Q2-2 is provided between the positive electrode of the second secondary battery B2 and the negative electrode of the third secondary battery B3.

A capacitor C200 is provided between the first intermediate connection point Q1-2 and the second intermediate connection point Q2-2. The capacitor C200 selectively passes an alternating-current component flowing between the first intermediate connection point Q1-2 and the second intermediate connection point Q2-2 and curbs passing of a direct-current component. Other components of the AC generation circuit 10A are the same as those of the first embodiment and thus detailed description thereof will be omitted.

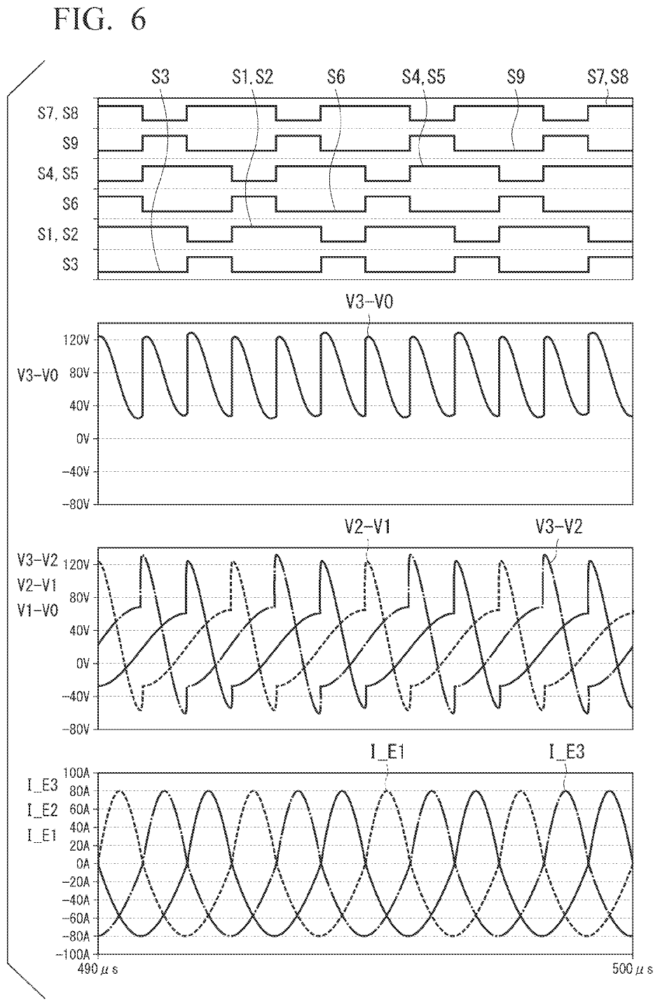

FIG. 6 is a diagram showing an example of changes in voltages and currents generated in the AC generation circuit 10A according to on/off of the switches of the child circuits of the second embodiment. In the first embodiment, the control unit 100 shifts the control phases of the switches of the first child circuit 10-1 and the second child circuit 10-2 by 180 degrees such that alternating currents with different phases are generated in the first child circuit 10-1 and the second child circuit 10-2. On the other hand, in the second embodiment, the control unit 100 shifts control phases of the switches of the first child circuit 10-1, the second child circuit 10-2, and the third child circuit 10-3 by 120 degrees such that alternating currents with different phases are generated in the first child circuit 10-1, the second child circuit 10-2, and the third child circuit 10-3. Since the principle of switching the connection relationship of the capacitors of each child circuit between serial/parallel connections with respect to the corresponding secondary battery in the second embodiment is the same as that in the first embodiment, detailed description thereof will be omitted.

Since the capacitor C100 and the capacitor C200 are provided in the second embodiment, it is possible to cause a certain amount of alternating-current component to pass between the first intermediate connection point Q1-1 and the second intermediate connection point Q2-1 and between Q1-2 and the second intermediate connection point Q2-2 while curbing a steep current flowing due to short-circuiting or the like. Therefore, even if the voltages of the first secondary battery B1, the second secondary battery B2, and the third secondary battery B3 are different at the time when the AC generation device 1A starts to operate, alternating current is generated such that a difference in alternating current energy is canceled, and the amplitudes of the current I_E1, the current LE2, and a current I_E3 flowing therethrough become uniform. Moreover, as compared to a comparative example which will be described later, a loss due to resistance can be reduced since no fuse is provided near the first intermediate connection point Q1-1, the second intermediate connection point Q2-1, the first intermediate connection point Q1-2, the second intermediate connection point Q2-2.

### Comparison with Comparative Example

### Comparative Example

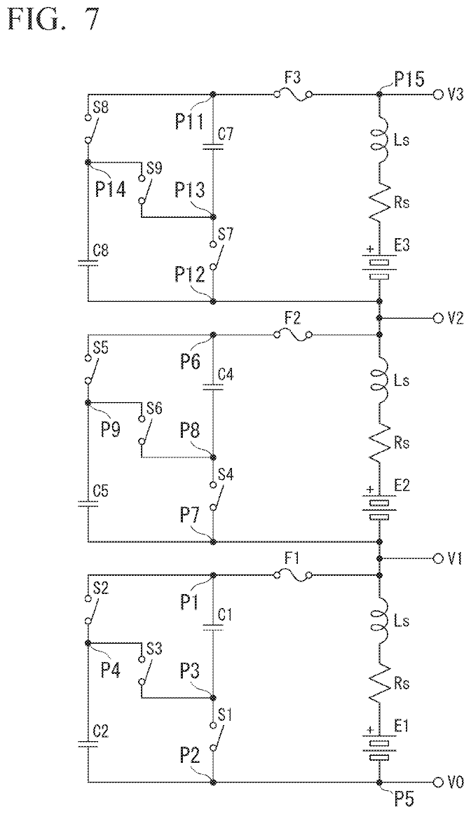

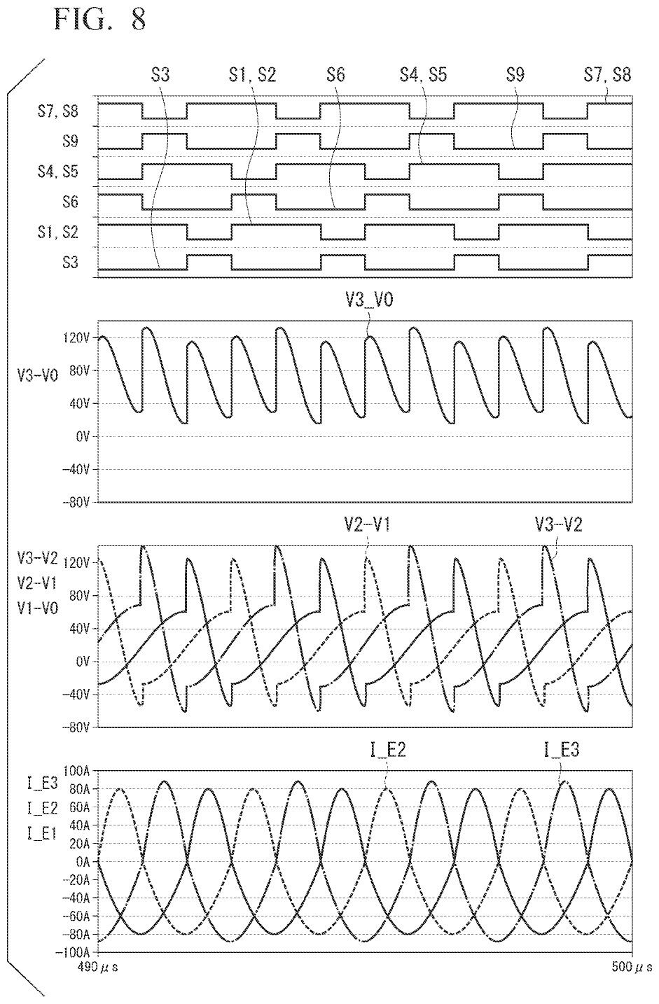

Here, comparison with a comparative example of the second embodiment will be described. FIG. 7 is a diagram showing an example of a configuration of an AC generation circuit of the comparative example of the second embodiment. In FIG. 7, those having the same functions as those of the second embodiment are denoted by the same reference numerals. As shown in FIG. 7, in AC generation circuit of the comparative example, the capacitor C100 and the capacitor C200 are not provided, the fuse F1 is provided between the contact P1 and the positive electrode of the first secondary battery B1, and a fuse F2 is provided between the contact P6 and the positive electrode of the second secondary battery B2. In this case, a loss due to the resistances of the fuses F1 and F2 increases. FIG. 8 is a diagram showing an example of changes in voltages and currents generated in the AC generation circuit 10A according to on/off of switches of child circuits of the comparative example of the second embodiment. In the comparative example, since the capacitor C100 and the capacitor C200 are not present, the amplitudes of the current I_E1, the current I_E2, and the current I_E3 may not be uniform when the voltages of the first secondary battery B1, the second secondary battery B2, and the third secondary battery B3 are different.

On the other hand, in the AC generation circuit 10A of the second embodiment, since the capacitor C100 and the capacitor C200 are provided, the capacitor C100 and the capacitor C200 adjust the potentials of the first intermediate connection point Q1-1 and the second intermediate connection point Q1-2, and thus the amplitude of the current I_E1, the amplitude of the current I_E2, and the amplitude of the current I_E3 become uniform and the AC generation device 1A can uniformly increase the temperatures of the first secondary battery B1 and the second secondary battery B2 and the temperature of the third secondary battery B3 and reduce a loss due to resistance.

### Third Embodiment

The second embodiment illustrates that a capacitor is provided between the two first intermediate connection points and the second intermediate connection points connected to each other when each of the secondary battery and the AC generation circuit is provided in three stages. Instead of this, when each of the secondary battery and the AC generation circuit is provided in multiple stages, a fuse may be provided at some or all positions at which a capacitor is not provided among positions at which a plurality of first intermediate connection points and a plurality of second intermediate connection points are connected. In a third embodiment, a four-stage secondary battery and AC generation circuit are provided, and a fuse is provided at positions at which a capacitor is not provided among positions at which a plurality of first intermediate connection points and a plurality of second intermediate connection points are connected.

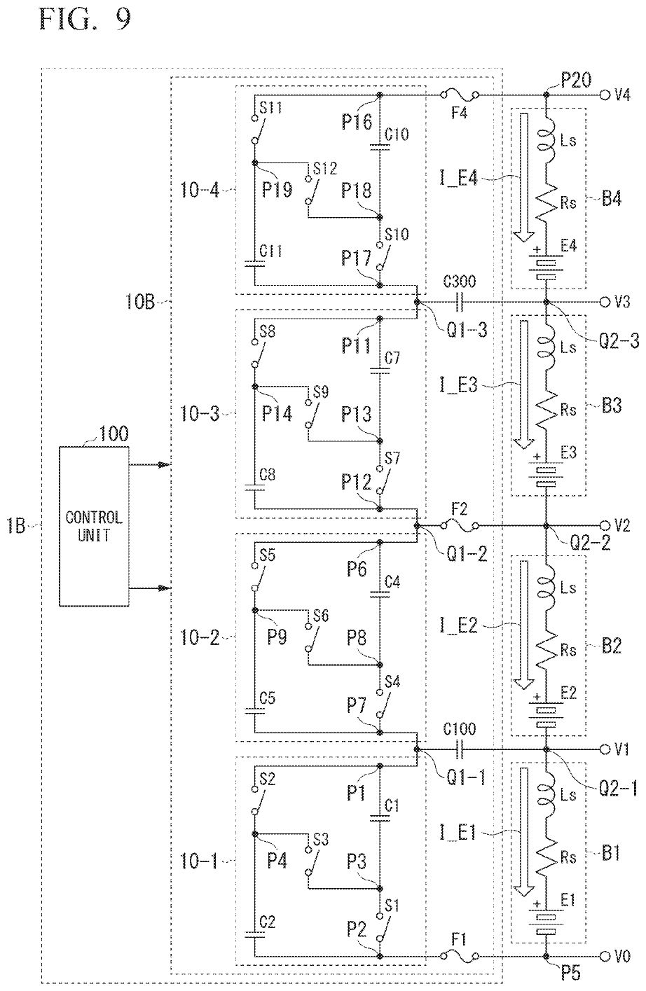

FIG. 9 is a diagram showing an example of a configuration of an AC generation device 1B and an AC generation circuit 10B of the third embodiment. The third embodiment includes a fourth child circuit 10-4 in addition to the configuration of the second embodiment.

A contact P16 on the positive electrode side of the fourth child circuit 10-4 is connected to the positive electrode of a fourth secondary battery B4 via a fuse F4. A contact P17 on the negative electrode side of the fourth child circuit 10-4 is connected to a first intermediate connection point Q1-3. Capacitors C10 and C11 and switches S10 to S12 for generating alternating current are provided between the contact P16 and the contact P17.

In the fourth child circuit 10-4, a first path through which the capacitor C10 and the switch S10 are connected in series and a second path through which the switch S11 and the capacitor C11 are connected in series are present in parallel between the contact P16 and the contact P17. A contact P18 between the capacitor C10 and the switch S10 and a contact P19 between the switch S11 and the capacitor C11 are connected through the third path. The switch S12 is provided on the third path. A second intermediate connection point Q2-3 is provided between the positive electrode of the third secondary battery B3 and the negative electrode of the fourth secondary battery B4.

The capacitor C100 is provided between the first intermediate connection point Q1-1 and the second intermediate connection point Q2-1. The fuse F2 is provided between the first intermediate connection point Q1-2 and the second intermediate connection point Q2-2. A capacitor C300 is provided between the first intermediate connection point Q1-3 and the second intermediate connection point Q2-3. The capacitor C100 selectively passes an AC component flowing between the first intermediate connection point Q1-1 and the second intermediate connection point Q2-1 and curbs passing of a DC component. The capacitor C300 selectively passes an AC component flowing between the first intermediate connection point Q1-3 and the second intermediate connection point Q2-3 and curbs passing of a DC component. The fuse F1 may be provided between the contact P2 and the contact P5. The operations of the fuses F1 to F3 are the same, and when the current flowing through the fuses becomes greater than a certain current, the fuses melt to cut off the current. Since other components of the AC generation circuit 10B are the same as those of the second embodiment, detailed description thereof will be omitted.

Since the capacitor C100 and the capacitor C300 are provided in the third embodiment, it is possible to pass a certain amount of AC components while curbing a steep current that flows due to short-circuiting or the like between the first intermediate connection point Q1-1 and the second intermediate connection point Q2-1 and between Q1-3 and the second intermediate connection point Q2-3. Therefore, even if the voltages of the first secondary battery B1 and the second secondary battery B2 or the third secondary battery B3 and the fourth secondary battery B4 are different when the AC generation device 1B starts to operate, alternating current is generated such that a difference in alternating current energy is canceled, and the amplitudes of the currents I_E1 and I_E2 or the currents I_E3 and I_E4 flowing therethrough become uniform. In this way, no fuse is provided near the first intermediate connection point Q1-1 and the second intermediate connection point Q2-1, and the first intermediate connection point Q1-3 and the second intermediate connection point Q2-3, and thus a loss due to resistance can be reduced as compared to a case in which fuses are all provided between the first intermediate connection point Q1-1 and the second intermediate connection points Q2-1, between the first intermediate connection points Q1-2 and the second intermediate connection points Q2-2, and between the first intermediate connection points Q1-3 and the second intermediate connection point Q2-3. The fuse F2 may be omitted.

In the third embodiment, the control unit 100 shifts control phases of switches of the first child circuit 10-1, the second child circuit 10-2, the third child circuit 10-3, and the fourth child circuit 10-4 by 90 degrees, for example, such that alternating currents with different phases are generated in the first child circuit 10-1, the second child circuit 10-2, the third child circuit 10-3, and the fourth child circuit 10-4.

Accordingly, since the capacitor C100 and the capacitor C300 are provided in the AC generation circuit 10B of the third embodiment, the capacitor C100 and the capacitor C300 adjust the potentials of the first intermediate connection point Q1-1 and the third intermediate connection point Q1-3, and thus the amplitude of the current I_E1, the amplitude of the current I_E2, the amplitudes of the current I_E3, and the current I_E4 become uniform, and the AC generation device 1B can uniformly increase the temperatures of the first secondary battery B1, the second secondary battery B2, the third secondary battery B3, and the fourth secondary battery B4, provide a higher voltage, and reduce a loss due to resistance.

### Modified Example 1 of Third Embodiment

Hereinafter, modified example 1 of the third embodiment will be described. In modified example 1 of the third embodiment, the first intermediate connection point and the second intermediate connection point are not present in at least one of adjacent sets of four-stage secondary batteries and AC generation circuits, and a fuse is provided on the side of any child circuit rather than a common intermediate connection point.

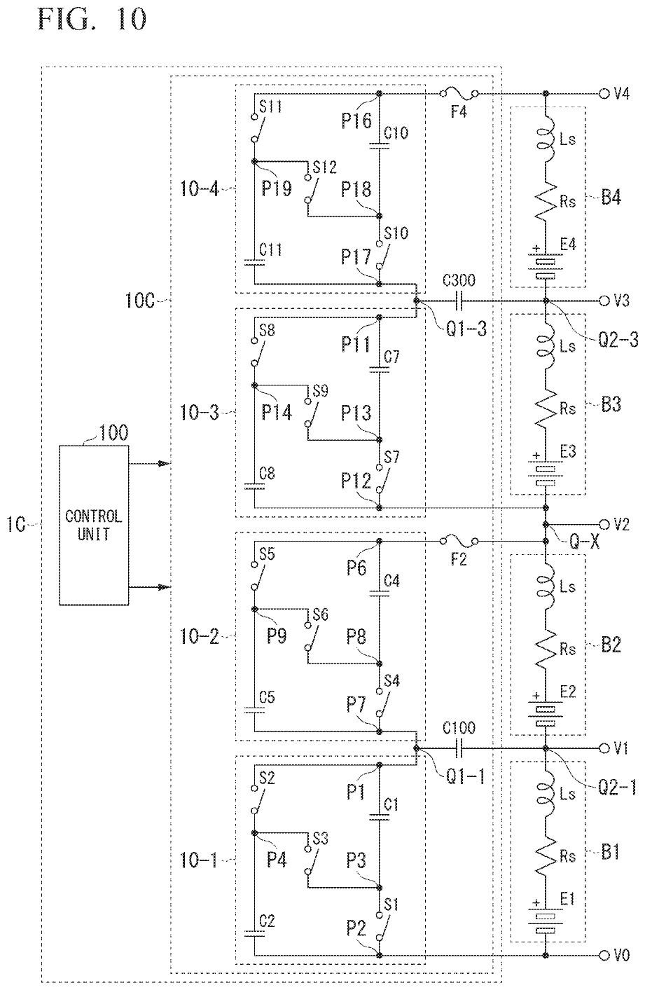

FIG. 10 is a diagram showing an example of a configuration of an AC generation device 1C and an AC generator circuit 10C of modified example 1 of the third embodiment. With respect to the third embodiment, the capacitor C100 is provided between the first intermediate connection point Q1-1 and the second intermediate connection point Q2-1, and the fuse F2 is provided on the side of the second child circuit 10-2 rather than a common intermediate connection point Q-X between the second child circuits 10-2 and the third child circuit 10-3 in the present modified example. A capacitor C300 is provided between the first intermediate connection point Q1-3 and the second intermediate connection point Q2-3, and a fuse F4 is provided between a first intermediate connection point Q1-4 and a second intermediate connection point Q2-4.

According to modified example 1 of the third embodiment, the amplitudes of currents I_E1 and I_E2, and the amplitudes of currents I_E3 and I_E4 become uniform, and thus the AC generation device 1C can uniformly increase the temperatures of the first secondary battery B1, the second secondary battery B2, the third secondary battery B3, and the fourth secondary battery B4 and reduce a loss due to resistance.

### Modified Example 2 of Third Embodiment

Hereinafter, modified example 2 of the third embodiment will be described. Modified example 1 of the third embodiment illustrates a configuration in which the first intermediate connection point and the second intermediate connection point are not present in at least one of adjacent sets of four-stage secondary batteries and AC generation circuits, and a fuse is provided on the side of any child circuit rather than the common intermediate connection point. On the other hand, in modified example 2 of the third embodiment, fuses are provided between a common intermediate connection point Q-X and two child circuits connected to the common intermediate connection point Q-X.

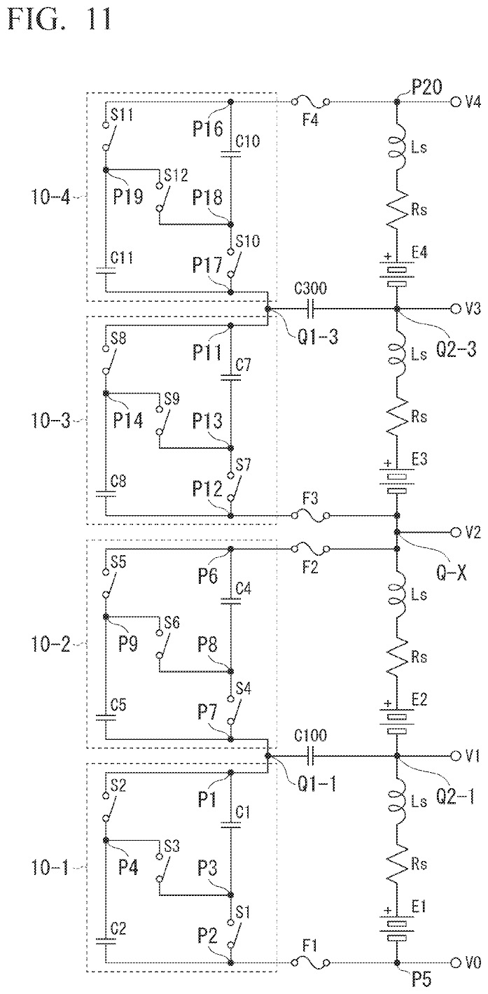

FIG. 11 is a diagram showing an example of a configuration of an AC generation device 1D and an AC generation circuit 10D of modified example 2 of the third embodiment. In modified example 2 of the third embodiment, the fuse F2 is provided on the side of the second child circuit 10-2 rather than the common intermediate connection point Q-X between the second child circuit 10-2 and the third child circuit 10-3, and a fuse F3 is provided on the side of the third child circuit 10-3 rather than the common intermediate connection point Q-X.

According to modified example 2 of the third embodiment, the amplitude of current I_E1, the amplitude of current I_E2, the amplitude of current I_E3, and the amplitude of current I_E4 become uniform, and the AC generation device 1C can uniformly increase the temperatures of the first secondary battery B1, the second secondary battery B1, the third secondary battery B3, and the fourth secondary battery B4 and increase the number of fuses to improve circuit stability.

<Arrangement of Capacitor>

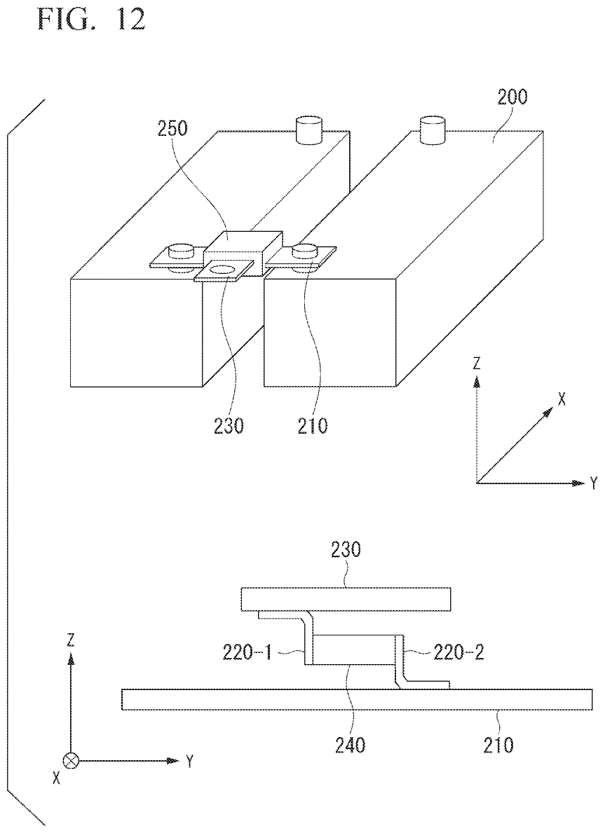

Here, arrangement and the like of a capacitor provided between the first intermediate connection point and the second intermediate connection point, such as the capacitor C100 will be described. FIG. 12 is a diagram showing an example of arrangement of a capacitor provided between the first intermediate connection point and the second intermediate connection point. The upper figure is a perspective view and the lower figure is an exploded view seen in the illustrated X direction. As shown in FIG. 12, a capacitor 240 (corresponding to the capacitor C100 and the like) provided between the first intermediate connection point and the second intermediate connection point may be connected to a bus bar 210 connecting a plurality of battery modules 200 that are a plurality of secondary batteries via a second connection tab 220-2 and further connected to a branch bus bar 230 via a first connection tab 220-1, and then covered with an insulating member by being sealed with a resin mold 250 or the like such that the bus bar 210 and the branch bus bar 230 are exposed. As the insulating member, a material other than the resin mold may be used. With this configuration, the part of the branch bus bar 230 is galvanically isolated from the battery module 200 and thus it does not become a live-line part, and it is not necessary to take measures for preventing the exposed portion of the branch bus bar 230 from short-circuiting at the time of assembling a battery pack.

Although the embodiments for carrying out the present invention have been described above using the embodiments, the present invention is not limited to these embodiments and various modifications and substitutions can be made without departing from the spirit or scope of the present invention.

What is claimed is:

1. An AC generation circuit comprising a plurality of child circuits connected to positive electrodes and negative electrodes of a plurality of secondary batteries connected in series,
wherein a negative electrode side of one of two adjacent child circuits among the plurality of child circuits and a positive electrode side of the other child circuit are connected at a first intermediate connection point,
the first intermediate connection point is connected to a second intermediate connection point at which a negative electrode of one of two adjacent secondary batteries among the plurality of secondary batteries and a positive electrode of the other secondary battery are connected, and
a capacitor is provided at least some of positions between one or more first intermediate connection points and one or more second intermediate connection points.

2. The AC generation circuit according to claim 1,
wherein the capacitor is provided at each of positions at which a plurality of first intermediate connection points and a plurality of second intermediate connection points are connected.

3. The AC generation circuit according to 1,
wherein the capacitor is provided at some of the positions at which the plurality of first intermediate connection points and the plurality of second intermediate connection points are connected, and a current limiting element is provided at some or all of positions at which the capacitor is not provided among the positions at which the plurality of first intermediate connection points and the plurality of second intermediate connection points are connected.

4. The AC generation circuit according to claim 1,
wherein each of the child circuits includes a plurality of child circuit capacitors, and a connection relationship of the child circuit capacitors is switched between serial/parallel connections with respect to a corresponding secondary battery to generate alternating current.

5. The AC generation circuit according to claim 1,
wherein the capacitor provided between the first intermediate connection point and the second intermediate connection point is connected to a branch bus bar constituting or connected to the first intermediate connection point via a first connection tab, and is connected to a bus bar constituting the second intermediate connection point via a second connection tab, the capacitor, the first connection tab, and the second connection tab are covered with an insulating member, and at least parts of the branch bus bar and the bus bar are exposed to the outside of a portion covered with the insulating member.

6. An AC generation device comprising:
the AC generation circuit according to claim 1; and
a control unit configured to cause alternating currents with different phases in some or all of the plurality of child circuits.
